(19) United States
(12) Patent Application Publication
(10) Pub. No.: US 2024/0314664 A1
(43) Pub. Date: Sep. 19, 2024

(54) HANDOVER TO A NON TERRESTRIAL NETWORK (NTN) DURING SMALL DATA TRANSMISSION (SDT)

(71) Applicant: Sony Group Corporation, Tokyo (JP)

(72) Inventors: Vivek SHARMA, Basingstoke (GB); Yassin Aden AWAD, Basingstoke (GB); Hideji WAKABAYASHI, Basingstoke (GB); Yuxin WEI, Basingstoke (GB)

(73) Assignee: Sony Group Corporation, Tokyo (JP)

(21) Appl. No.: 18/276,645

(22) PCT Filed: Mar. 25, 2022
(86) PCT No.: PCT/EP2022/057982

§ 371 Date: Aug. 10, 2023

(30) Foreign Application Priority Data
Apr. 13, 2021 (EP) 21168206.7

(51) Int. Cl. H04W 36/32; H04W 36/08; H04W 84/06

(52) U.S. Cl. CPC H04W 36/322; H04W 36/08; H04W 84/06

(57) ABSTRACT

A method of operating a communications device for transmitting signals to and/or receiving signals from a wireless communications network is provided. The method comprises determining that the communications device has uplink data to transmit to the wireless communications network, transmitting to a first cell of the wireless communications network, while the communications device is located within a coverage region of the first cell, one or more of a plurality of portions of the uplink data, determining, as a result of a change in a relative position of the communications device with respect to the coverage region of the first cell, that the communications device should select a different cell to continue the transmission of the uplink data, selecting a second cell of the wireless communications network, and receiving, from the second cell, a reconfiguration message.

### BACKGROUND

### Field of Disclosure

The present disclosure relates generally to wireless communications networks, and specifically to methods and devices for handling the transmission of uplink data more efficiently.

The present application claims the Paris Convention priority from European patent application number EP21168206.7, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these and future networks, i.e. geographic locations where access to the networks is possible, may be expected to increase ever more rapidly.

Current and future wireless communications networks are expected to routinely and efficiently support communications with a wider range of devices associated with a wider range of data traffic profiles and types than previously developed systems are optimised to support. For example it is expected that future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for more advanced wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

One example area of current interest in this regard includes so-called “non-terrestrial networks”, or NTN for short. 3GPP has proposed in Release 15 of the 3GPP specifications to develop technologies for providing coverage by means of one or more antennas mounted on airborne or space-borne vehicles [1].

Non-terrestrial networks may provide service in areas that cannot be covered by terrestrial cellular networks (i.e. those where coverage is provided by means of land-based antennas), such as isolated or remote areas, on board aircraft or vessels) or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of different types of network infrastructure equipment and requirements for coverage enhancement give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device for transmitting signals to and/or receiving signals from a wireless communications network. The method comprises determining that the communications device has uplink data to transmit to the wireless communications network, transmitting to a first cell of the wireless communications network, while the communications device is located within a coverage region of the first cell, one or more of a plurality of portions of the uplink data, determining, as a result of a change in a relative position of the communications device with respect to the coverage region of the first cell, that the communications device should select a different cell to continue the transmission of the uplink data, selecting a second cell of the wireless communications network, and receiving, from the second cell, a reconfiguration message.

The reconfiguration message comprises a status report message for use the communications device in determining which of the plurality of portions of the uplink data are to be transmitted to the second cell.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is reproduced from [1], and illustrates a first example of a non-terrestrial network (NTN) featuring an access networking service based on a satellite/aerial platform with a bent pipe payload;

FIG. 5 is reproduced from [1], and illustrates a second example of an NTN featuring an access networking service based on a satellite/aerial platform that incorporates a gNodeB;

FIG. 6 schematically shows an example of a wireless communications system comprising an NTN part and a terrestrial network (TN) part which may be configured to operate in accordance with embodiments of the present disclosure;

FIG. 7 shows an example of how movement of satellites may cause a user equipment (UE) to have to retransmit an entire uplink data transmission;

FIG. 8 is a part schematic, part message flow diagram representation of a wireless communications network comprising a communications device and infrastructure equipment in accordance with embodiments of the present technique;

FIG. 9 shows an example, based on the example of FIG. 7, of how UE may more efficiently transmit uplink data to moving satellites without having to retransmit the entire uplink data transmission in accordance with embodiments of the present technique; and

FIG. 10 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

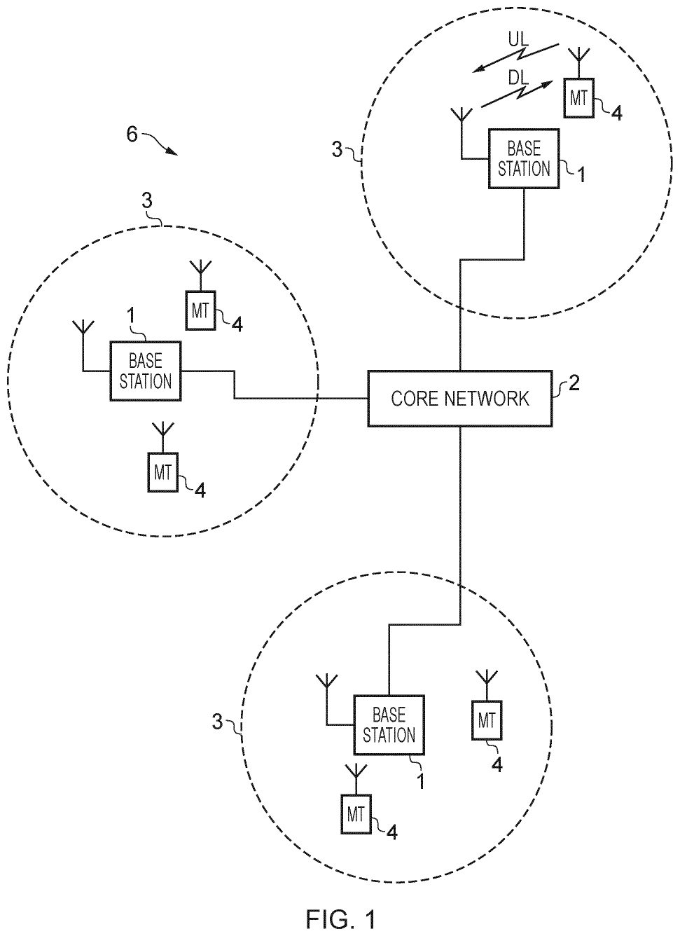

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

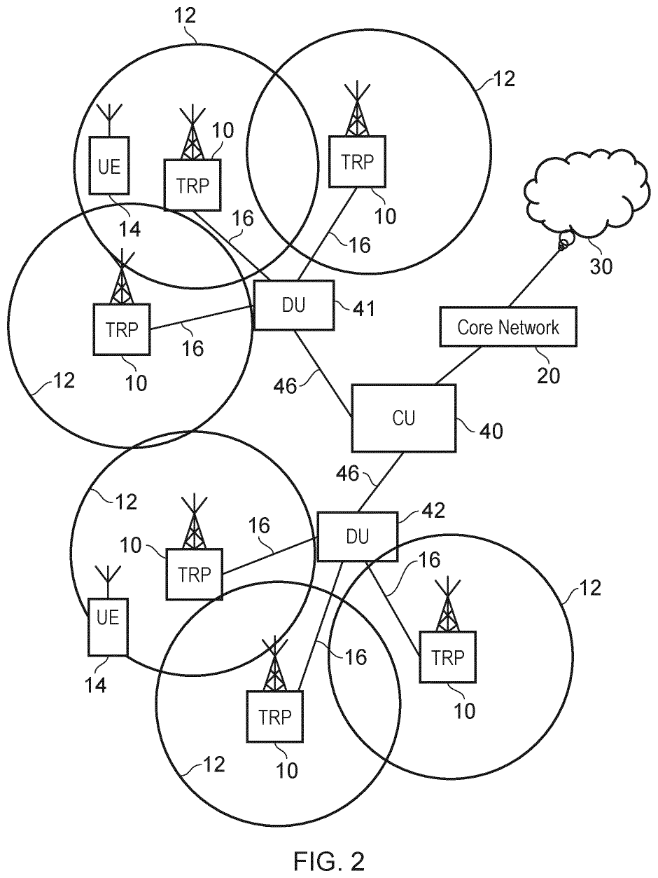

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

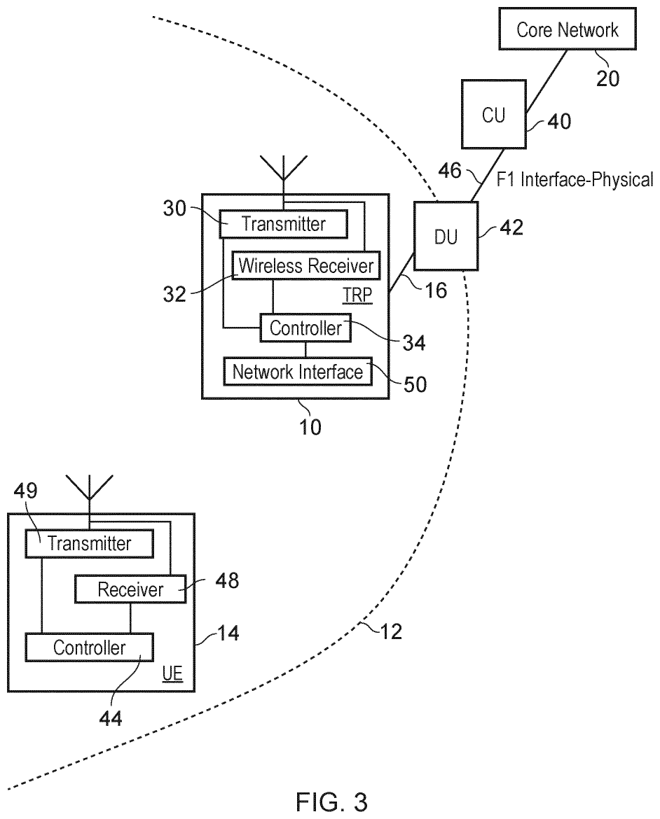

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Small Data Transmission (SDT)

Recent enhancements have been proposed for NR, such as small data transmissions while the UE is in the RRC_INACTIVE state. As would be well understood by those skilled in the art, the RRC_INACTIVE is one of three RRC states (along with RRC_IDLE and RRC_CONNECTED) in which an NR UE may operate. In the connected state, a UE has an active RRC connection to the 5G core network. In the idle state, the UE does not have a connection established with the 5G core network. In the inactive state, the UE does have an RRC connection to the 5G core network, but this connection is suspended but not released, such that it may transition to RRC_CONNECTED more efficiently from RRC_INACTIVE than from RRC_IDLE. With reference to [3], some specific examples of small data transmission and infrequent data traffic may include the following use cases:
Smartphone applications:
   Traffic from Instant Messaging services;
   Heart-beat/keep-alive traffic from IM/email clients and other applications; and
   Push notifications from various applications;
Non-smartphone applications:
   Traffic from wearable devices (e.g. periodic positioning information);
   Sensors (e.g., Industrial Wireless Sensor Networks transmitting temperature or pressure readings, periodically or in an event-triggered manner); and
   Smart meters and smart meter networks sending periodic meter readings.

In addition, based on [3] as mentioned above, uplink small data transmissions have been enabled for UEs in the RRC_INACTIVE state, for Random Access (RACH) based schemes (i.e. 2-step and 4-step RACH, which are well known to those skilled in the art). This includes general procedures to enable user plane data transmissions for small data packets in the inactive state (using either MsgA of the 2-step RACH procedure or Msg3 of the 4-step RACH procedure), and enables flexible payload sizes larger than the Rel-16 Common Control Channel (CCCH) message size that is possible currently for a UE in the RRC_INACTIVE state to transmit small data in MsgA or Msg3 to support user plane data transmission in the uplink. The small data is not always a one-shot transmission however, and so depending on the data available at the UE's buffer, subsequent transmissions of small data on the uplink should be supported which may take several iterations before all data in the UE's buffer is transmitted completely.

### Non-Terrestrial Networks (NTNs)

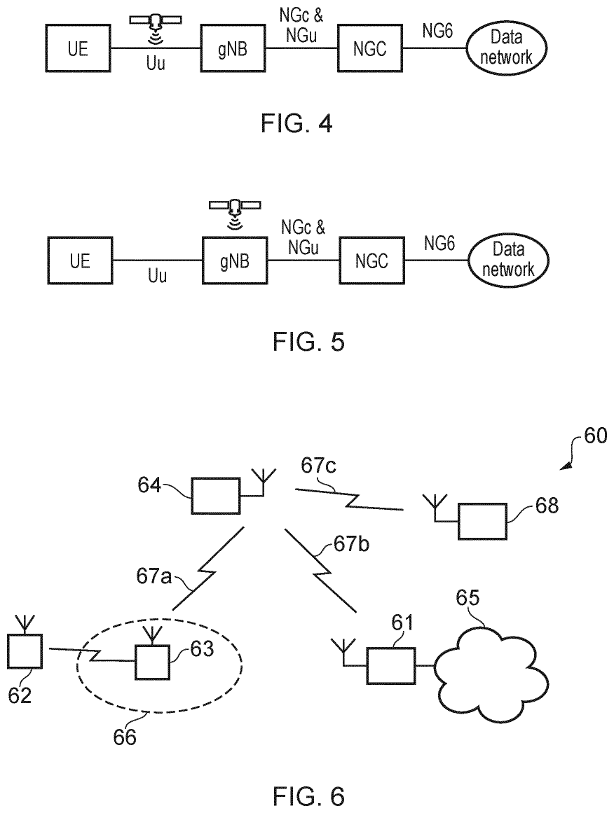

An overview of NR-NTN can be found in [1], and much of the following wording, along with FIGS. 4 and 5, has been reproduced from that document as a way of background.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by terrestrial 5G network (isolated/remote areas, on board aircrafts or vessels) and underserved areas (e.g. sub-urban/rural areas) to upgrade the performance of limited terrestrial networks in cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks operating alone or to integrated terrestrial and Non-Terrestrial networks. They will impact at least coverage, user bandwidth, system capacity, service reliability or service availability, energy consumption and connection density. A role for Non-Terrestrial Network components in the 5G system is expected for at least the following verticals: transport, Public Safety, Media and Entertainment, eHealth, Energy, Agriculture, Finance and Automotive. It should also be noted that the same NTN benefits apply to other technologies such as 4G and/or LTE technologies, and that while NR is sometimes referred to in the present disclosure, the teachings and techniques presented herein are equally applicable to other technologies such as 4G and/or LTE.

FIG. 4 illustrates a first example of an NTN architecture based on a satellite/aerial platform with a bent pipe payload, meaning that the signal received from the UE is simply reflected and sent back down to Earth by the satellite/aerial platform, with only frequency or amplification changing; i.e. acting like a pipe with a u-bend. In this example NTN, the satellite or the aerial platform will therefore relay a “satellite friendly” NR (or LTE) signal between the gNodeB (or eNodeB) and UEs in a transparent manner.

FIG. 5 illustrates a second example of an NTN architecture based on a satellite/aerial platform comprising a gNodeB (or eNodeB in the examples of the present disclosure) which may be referred to as non-terrestrial infrastructure equipment. In this example NTN, the satellite or aerial platform carries a full or part of a gNodeB/eNodeB to generate or receive an NR (or LTE) signal to/from the UEs. For example, in addition to frequency conversion and amplification, the satellite/aerial platform may also decode a received signal. This requires the satellite or aerial platform to have sufficient on-board processing capabilities to be able to include a gNodeB or eNodeB functionality.

FIG. 6 schematically shows an example of a wireless communications system 60 which may be configured to operate in accordance with embodiments of the present disclosure. The wireless communications system 60 in this example is based broadly around an LTE-type or 5G-type architecture. Many aspects of the operation of the wireless communications system/network 60 are known and understood and are not described here in detail in the interest of brevity. Operational aspects of the wireless communications system 60 which are not specifically described herein may be implemented in accordance with any known techniques, for example according to the current LTE standards or the current 5G standards.

The wireless communications system 60 comprises a core network part 65 (which may be a 4G core network or a 5G core network) in communicative connection with a radio network part. The radio network part comprises a base station (g-node B) 61 connected to a non-terrestrial network part 64. The non-terrestrial network part 64 may be an example of infrastructure equipment. Alternatively, or in addition, the non-terrestrial network part 64 may be mounted on a satellite vehicle or on an airborne vehicle.

The non-terrestrial network part 64 may communicate with a communications device 63, located within a cell 66, by means of a wireless access interface provided by a wireless communications link 67a. For example, the cell 66 may correspond to the coverage area of a spot beam generated by the non-terrestrial network part 64. The boundary of the cell 66 may depend on an altitude of the non-terrestrial network part 64 and a configuration of one or more antennas of the non-terrestrial network part 64 by which the non-terrestrial network part 64 transmits and receives signals on the wireless access interface.

The non-terrestrial network part 64 may be a satellite in an orbit with respect to the Earth, or may be mounted on such a satellite. For example, the satellite may be in a geo-stationary earth orbit (GEO) such that the non-terrestrial network part 64 does not move with respect to a fixed point on the Earth's surface. The geo-stationary earth orbit may be approximately 36,786 km above the Earth's equator. The satellite may alternatively be in a low-earth orbit (LEO), in which the non-terrestrial network part 64 may complete an orbit of the Earth relatively quickly, thus providing moving cell coverage. Alternatively, the satellite may be in a non-geostationary orbit (NGSO), so that the non-terrestrial network part 64 moves with respect to a fixed point on the Earth's surface. The non-terrestrial network part 64 may be an airborne vehicle such as an aircraft, or may be mounted on such a vehicle. The airborne vehicle (and hence the non-terrestrial network part 64) may be stationary with respect to the surface of the Earth or may move with respect to the surface of the Earth.

In FIG. 6, the terrestrial station 61 is shown as ground-based, and connected to the non-terrestrial network part 64 by means of a wireless communications link 67b. The non-terrestrial network part 64 receives signals representing downlink data transmitted by the base station 61 on the wireless communications link 67b and, based on the received signals, transmits signals representing the downlink data via the wireless communications link 67a providing the wireless access interface for the communications device 63. Similarly, the non-terrestrial network part 64 receives signals representing uplink data transmitted by the communications device 63 via the wireless access interface comprising the wireless communications link 67a and transmits signals representing the uplink data to the terrestrial station 61 on the wireless communications link 67b. The wireless communications links 67a, 67b may operate at a same frequency, or may operate at different frequencies.

The extent to which the non-terrestrial network part 64 processes the received signals may depend upon a processing capability of the non-terrestrial network part 64. For example, the non-terrestrial network part 64 may receive signals representing the downlink data on the wireless communication link 67b, amplify them and (if needed) re-modulate onto an appropriate carrier frequency for onwards transmission on the wireless access interface provided by the wireless communications link 67a. Alternatively, the non-terrestrial network part 64 may be configured to decode the signals representing the downlink data received on the wireless communication link 67b into un-encoded downlink data, re-encode the downlink data and modulate the encoded downlink data onto the appropriate carrier frequency for onwards transmission on the wireless access interface provided by the wireless communications link 67a.

The non-terrestrial network part 64 may be configured to perform some of the functionality conventionally carried out by a base station (e.g. a gNodeB or an eNodeB), such as base station 1 as shown in FIG. 1. In particular, latency-sensitive functionality (such as acknowledging a receipt of the uplink data, or responding to a RACH request) may be performed by the non-terrestrial network part 64 partially implementing some of the functions of a base station.

As mentioned above, a base station may be co-located with the non-terrestrial network part 64; for example, both may be mounted on the same satellite vehicle or airborne vehicle, and there may be a physical (e.g. wired, or fibre optic) connection on board the satellite vehicle or airborne vehicle, providing the coupling between the terrestrial station 61 and the non-terrestrial network part 64. In such co-located arrangements, a wireless communications feeder link between the terrestrial station 61 and another terrestrial station (not shown) may provide connectivity between the terrestrial station 61 (co-located with the non-terrestrial network part 64) and the core network part 65.

The terrestrial station 61 may be a NTN Gateway that is configured to transmit signals to the non-terrestrial network part 64 via the wireless communications link 67b and to communicate with the core network part 65. That is, in some examples the terrestrial station 61 may not include base station functionality. For example, if the base station is co-located with the non-terrestrial network part 64, as described above, the terrestrial station 61 does not implement base station functionality. In other examples, the base station may be co-located with the NTN Gateway in the terrestrial station 61, such that the terrestrial station 61 is capable of performing base station (e.g. gNodeB or eNodeB) functionality.

In some examples, even if the base station is not co-located with the non-terrestrial network part 64 (such that the base station functionality is implemented by a ground-based component), the terrestrial station 61 may not necessarily implement the base station functionality. In other words, the base station (e.g. gNodeB or eNodeB) may not be co-located with the terrestrial station 61 (NTN Gateway). In this manner, the terrestrial station 61 (NTN Gateway) transmits signals received from the non-terrestrial network part 64 to a base station (not shown in FIG. 6). In such an example, the base station (e.g. gNodeB or eNodeB) may be considered as being part of core network part 65, or may be separate (not shown in FIG. 6) from the core network part 65 and located logically between the terrestrial station 61 (NTN Gateway) and the core network part 65.

In some cases, the communications device 63 shown in FIG. 6 may be configured to act as a relay node. That is, it may provide connectivity to one or more terminal devices such as the terminal device 62. When acting as a relay node, the communications device 63 transmits and receives data to and from the terminal device 62, and relays it, via the non-terrestrial network part 64 to the terrestrial station 61. The communications device 63, acting as a relay node, may thus provide connectivity to the core network part 65 for terminal devices which are within a transmission range of the communications device 63.

In some cases, the non-terrestrial network part 64 is also connected to a ground station 68 via a wireless link 67c. The ground station may for example be operated by the satellite operator (which may be the same as the mobile operator for the core and/or radio network or may be a different operator) and the link 67c may be used as a management link and/or to exchange control information. In some cases, once the non-terrestrial network part 64 has identified its current position and velocity, it can send position and velocity information to the ground station 68. The position and velocity information may be shared as appropriate, e.g. with one or more of the UE 63, terrestrial station 61 and base station, for configuring the wireless communication accordingly (e.g. via links 67a and/or 67b).

It will be apparent to those skilled in the art that many scenarios can be envisaged in which the combination of the communications device 63 and the non-terrestrial network part 64 can provide enhanced service to end users. For example, the communications device 63 may be mounted on a passenger vehicle such as a bus or train which travels through rural areas where coverage by terrestrial base stations may be limited. Terminal devices on the vehicle may obtain service via the communications device 63 acting as a relay, which communicates with the non-terrestrial network part 64.

A challenge of conventional cellular communications techniques may be the relatively high rate at which cell changes occur for the communications device 63 obtaining service from one or more non-terrestrial network parts. For example, where the non-terrestrial network part 64 is mounted on a LEO satellite, the non-terrestrial network part 64 may complete an orbit of the Earth in around 90 minutes; the coverage of a cell generated by the non-terrestrial network part 64 will move very rapidly, with respect to a fixed observation point on the surface of the Earth. Similarly, it may be expected in some cases that the communications device 63 may be mounted on an airborne vehicle itself, having a ground speed of several hundreds of kilometres per hour.

A study has been completed by 3GPP on solutions for NR to support NTN, as detailed in [4]. This study [4] focuses on use cases for satellite access in 5G and service requirements, as well as on evaluating solutions and impacts on RAN protocols and architecture. The study resulted in a new work item [5] that has already been started in RAN working groups to specify the enhancements identified for NR, especially for satellite access via transparent payload LEO and GEO satellites with implicit compatibility to support high altitude platform stations (HAPS) and air to ground (ATG) scenarios.

In addition, 3GPP initiated a new study item [6] for deploying narrowband internet of things (NB-IoT)/enhanced machine type communications (eMTC) over NTN, with the following justifications as detailed in [6]:
IoT operation is critical in remote areas with low/no cellular connectivity for many different industries, including for example:
   Transportation (maritime, road, rail, air) & logistics;
   Solar, oil & gas harvesting;
   Utilities;
   Farming;
   Environment monitoring; and
   Mining etc.; and
From the objectives perspective, at least the following items are addressed in [6]:
   Aspects related to random access procedure/signals [RAN1, RAN2];
   Mechanisms for time/frequency adjustment including Timing Advance, and UL frequency compensation indication [RAN1, RAN2];
   Timing offset related to scheduling and hybrid automatic repeat request acknowledgement (HARQ-ACK) feedback [RAN1, RAN2];
   Aspects related to HARQ operation [RAN2, RAN1];
   General aspects related to timers (e.g. scheduling requests (SR), discontinuous reception (DRX), etc.) [RAN2];
   RAN2 aspects related to idle mode and connected mode mobility [RAN2];
      Radio link failure (RLF)-based for NB-ToT;
      Handover-based for eMTC;
   System information enhancements [RAN2]; and
   Tracking area enhancements [RAN2].

An NB-IoT UE being connected via a satellite network (IoT-NTN) may, like any UE, be in bad coverage at certain times and thus may require multiple repetitions, especially on the uplink as the NB-IoT UE is likely to be uplink power limited. Traditionally, NB-IoT UEs are expected to transmit small amounts of data and, due to cost and complexity reasons, NB IoT UEs in terrestrial networks (TN) do not support connected mode mobility and measurements. Mobility is supported for NB-IoT UEs, as mentioned above with reference to [6], via RLF and a subsequent Radio Resource Control (RRC) re-establishment procedure. This implies that an NB-IoT UE connected to a serving cell will either move to the serving cell's edge or wait for the serving cell to disappear and declare RLF, after which the UE will trigger an RRC re-establishment procedure. This RRC re-establishment procedure is a lengthy procedure, and may be understood as a compromise for the reduced complexity and best-effort traffic associated with NB-IoT.

As those skilled in the art would understand, RLF may be detected by a UE (or indeed by an eNodeB) based on any one or more of a number of things, for example, the measured reference signal receive power (RSRP) is below a threshold, the UE fails to decode a physical downlink control channel (PDCCH) or physical downlink shared channel (PDSCH) (due to low RSRP for example), or no acknowledgement (ACK or NACK) is received in response to a transmitted packet.

### PDCP Status Report

The transmission of Packet Data Convergence Protocol (PDCP) status reports is a procedure, utilised for example in LTE and NR mobile telecommunication systems, whereby the PDCP receiving entity can indicate missing sequence numbers (SNs) of PDCP protocol data units (PDUs) to the PDCP transmitting entity. This procedure may be supported for downlink traffic; i.e. NB-IoT UE may send a PDCP status report if the statusReportRequired information element (IE) is configured by the network. However, the network does not send PDCP status reports to a NB-IoT UE, due to a limitation in the PDCP specification which specifically prohibits this (see for example section 5.3.2 in [7]), as is discussed in further detail below. PDCP status reports are used only during handover and when a PDCP entity is re-established. Since an NB-IoT device generally has small amounts of data to transmit, and mobility is based on RLF and not handover, there is essentially no need to implement the reception of PDCP status reports by NB-IoT UEs, hence allowing the complexity of such devices to be reduced.

Within the context of NB-IoT in NTN, moving satellites introduce a new challenge for uplink transmissions from NB-IoT UEs, where changing coverage is an issue and thus there may be a need to enhance presently defined functionality.

LEO satellites, and medium Earth orbit (MEO) which orbit in a region between LEO and geostationary satellites, move with respect to the Earth's surface, and so mobility will be more frequent for NTN comprising such satellites than for TN—even for UEs such as NB-IoT UEs. As mentioned above, it has already been defined that NB-IoT mobility for NTN, just like TN, will be based on RLF rather than handover. However, if a UE has a few PDCP PDUs to transmit, and/or the UE is utilising physical layer repetitions (because for example it is operating in extended coverage), it is possible that the UE may only be able to transmit some and not all of the PDUs/repetitions to the network before having to switch satellites due to their movement. In accordance with known implementations, the UE would be forced to restart the transmission of the PDCP PDUs again, while due to the predictive movement of the satellites, there may be further similar failures in transmitting all of the PDUs/repetitions which results in a very inefficient manner of transmission for NB-IoT UEs in NTN.

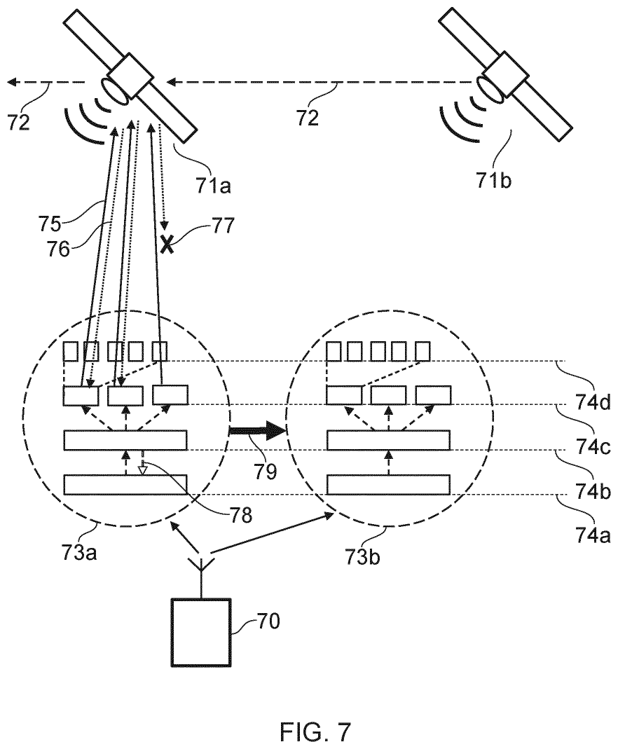

FIG. 7 shows an example of how movement 72 of satellites 71a, 71b may cause a UE 70 to have to retransmit an entire uplink data transmission 73a. The UE 70, in the example illustrated by FIG. 7, is engaged in communication with a cell of the satellite 71a.

The application layer 74a in the UE generates a packet which is passed on to the PDCP layer 74b as a PDCP service data unit (SDU). The PDCP layer 74b performs functions like security, header compression etc. (if required), and then passes on a PDCP PDU corresponding to the received SDU to the radio link control (RLC) layer 74c. The RLC layer 74c performs segmentation on the PDCP PDU based on uplink grant or resource allocation, and three such segments of the SDU/PDU are shown in FIG. 7 as an example. A MAC transport block is then prepared in the MAC entity of the UE 70 and retransmissions take place based on the configured number of retransmissions at the physical layer 74d.

As can be seen in FIG. 7, RLC PDUs #1 and #2 are transmitted successfully and an RLC ACK is received (if RLC acknowledged mode (RLC-AM) was used). For example, the first segment RLC PDU #1 75 is transmitted by the UE 70 to the first satellite 71a, and in return after successful reception, the first satellite 71a returns an ACK 76 to the UE 70. However, while transmitting the third segment, the satellite cell disappears due to the movement 72 of the satellite 71a, and so the ACK 77 transmitted by the satellite cell for this segment is never received by the UE 70. The UE (which may for example be an NB-IoT UE) will then perform RLF and re-establishment 79. In this process, the UE's 70 PDCP entity may typically flush the data, and the application layer 74a may either assume a NACK for the transmission 73a or an explicit NACK 78 may be received from the AS protocol stack. Furthermore, the UE 70—particularly if RLC-AM is not used—may not know if the first cell or the new cell have received the PDU segments previously transmitted by the UE 70.

Here, the UE 70 may start from scratch with uplink transmission 73b in the new cell, which may be another cell operated by satellite 71a or may be a cell operated by a different satellite 71b, where uplink transmission 73b which corresponds exactly to initial transmission 73a. If the UE 70 happens to be unlucky, then the same situation may arise again in the new cell before the satellite cell disappears again. This may lead to the UE 70 either being unable to transmit at all, or with minimum efficiency of radio resources as it needs to restart the transmission 73a, 73b from scratch each time it tries to transmit the data.

The RLC ACK 76 for RLC-AM may either be delayed or missing depending on the RLC Poll PDU setting (i.e. an ACK should be sent after x amount of bytes or y number of PDUs being sent/received). So, in the worst case scenario, no RLC ACK like ACK 77 may be received, even though a few RLC PDU transmissions were actually successful.

A similar situation may also arise when the UE 70 (which in such an example may not be NB-IoT UE) is performing a small data transmission with an NTN cell. Here, the UE 70 will be in the RRC_INACTIVE state for the SDT, and mobility is therefore based on cell selection/reselection. If issues arise due to movement of the satellites for example during the SDT, which mean that the UE 70 is unable to successfully transmit the entire SDT, then it may have to start from scratch in the manner shown in FIG. 7.

Embodiments of the present disclosure thus provide solutions to such issues, and generally relate to the provision, by the wireless communications network, of a PDCP status report to a UE where this UE may for example be an NB-IoT UE or a UE in RRC_INACTIVE state performing a small data transmission.

Status Report for NB-IoT UE and/or SDT in Satellite Network

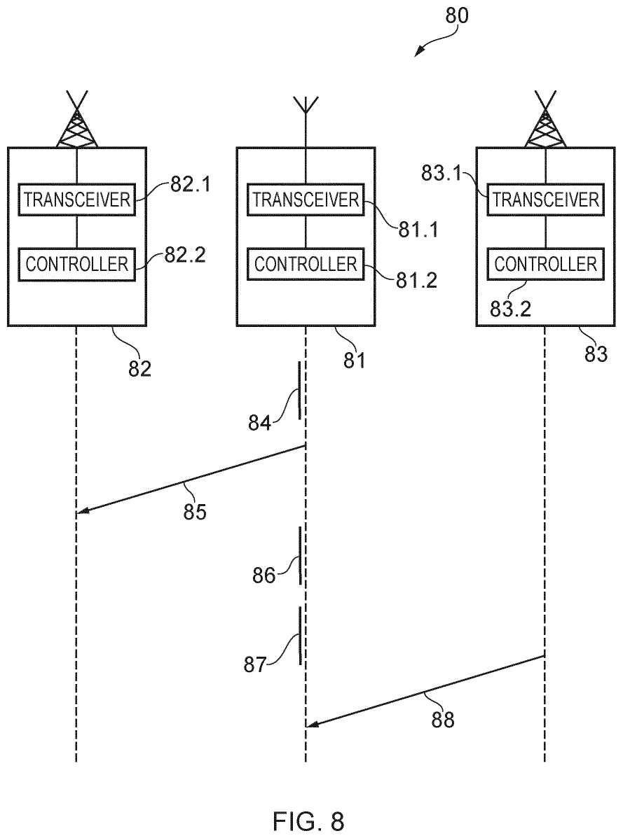

FIG. 8 shows schematic representation of a wireless communications system 80 comprising a communications device 81 and two infrastructure equipment 82, 83 forming part of a wireless communications network. The communications device 81 is configured to transmit signals to and/or to receive signals from the infrastructure equipment 82, 83. The communications device 81 and infrastructure equipment 82, 83 each comprise a transceiver (or transceiver circuitry) 81.1, 82.1, 83.1 and a controller (or controller circuitry) 81.2, 82.2, 83.2. Each of the controllers 81.2, 82.2, 83.2 may be, for example, a microprocessor, a CPU, or a dedicated chipset, etc. The transceivers (or transceiver circuitry) 81.1, 82.1, 83.1 of one or more of the communications device 81 and infrastructure equipment 82, 83 may comprise both a transmitter and a receiver, or may—instead of being a transceiver—be a standalone transmitter and receiver pair. It would be appreciated by those skilled in the art that the infrastructure equipment 82, 83 (as well as in some arrangements the communications device 81 and any other infrastructure equipment or communications devices operating in accordance with embodiments of the present technique) may comprise a plurality of (or at least, one or more) transceivers (or transceiver circuitry) 81.1, 82.1, 83.1.

Specifically, as is shown by FIG. 8, the transceiver circuitry 81.1 and the controller circuitry 81.2 of the communications device 81 are configured in combination to determine 84 that the communications device 81 has uplink data to transmit to the wireless communications network, to transmit 85 to a first cell (e.g. formed by a first of the infrastructure equipment 82) of the wireless communications network, while the communications device 81 is located within a coverage region of the first cell, one or more of a plurality of portions of the uplink data, to determine 86, as a result of a change in a relative position of the communications device 81 with respect to the coverage region of the first cell, that the communications device 81 should select a different cell to continue the transmission of the uplink data, to select 87 a second cell (e.g. formed by a second of the infrastructure equipment 83) of the wireless communications network (where this second cell determines based on an indication received from the first cell, or from elsewhere in the network, that the communications device 81 has selected it to continue the transmission of the uplink data), and to receive 88, from the second cell (e.g. from the second infrastructure equipment 83), a reconfiguration message. Here, the reconfiguration message comprises a status report message (e.g. a packet data convergence protocol, PDCP, status report message) for use by (e.g. a PDCP entity of) the communications device 81 in determining which of the plurality of portions of the uplink data are to be transmitted to the second cell (e.g. to the second infrastructure equipment 83).

While the status report message may be a PDCP status report message as mentioned above and as described in at least some examples herein, those skilled in the art would appreciate that the status report message may alternatively be an RLC status report (RLC ACKs). Here, the whole mechanism may either be supported in the RLC layer, or the RLC status report may be embedded in the PDCP status report. If RLC segments or PDUs were to be received across different cells, then RLC PDUs should be of the same size across different cells. Considering UE radio conditions don't change much in an NTN environment for example, the same RLC PDU size may be possible in both source and target cells. However, the scheduler must provide the UL grant to fit the segmented RLC PDU. So therefore, the source cell (e.g. the first cell operated by the first infrastructure equipment 82) must share the size of the RLC segment with the target cell (e.g. the second cell operated by the second infrastructure equipment 83), and this can also be part of the PDCP status report

In the example communications system shown in FIG. 8, and in accordance with embodiments of the present technique, the infrastructure equipment 82, 83 may each be non-terrestrial infrastructure equipment, where the non-terrestrial infrastructure equipment each either may be located at one of a satellite, an airborne vehicle or an airborne platform, or may be or be ground-based but in communication with one of a satellite, an airborne vehicle or an airborne platform. In other words, the wireless communications network is a non-terrestrial network (NTN) where the communications device 81 is configured to transmit the signals to and/or to receive the signals from the NTN, the communications device 81 is configured to communicate with the infrastructure equipment 82, 83 which are non-terrestrial infrastructure equipment forming part of the NTN via at least one of a plurality of satellite spot beams which provides a wireless access interface for transmitting the signals to and/or receiving the signals from the non-terrestrial infrastructure equipment 82, 83 within a coverage region formed by the at least one or more of the spot beams. Here, the change in the relative position of the communications device 81 with respect to the coverage region of the first cell may be (at least in part) due to movement with respect to the ground of the non-terrestrial infrastructure equipment 82 which forms the first cell. Movement of the communications device 81 itself may also, or may instead, play a role in the change in the relative position of the communications device 81 with respect to the coverage region of the first cell.

In the following description reference to a coverage area being formed by a spot beam provided by a non-terrestrial network infrastructure equipment such as non-terrestrial infrastructure equipment 82, 83 should also be interpreted as being a cell as an alternative because each satellite may provide one or more spot beams each having their own cell identity, in which case there is cell selection/reselection. For cases in which the infrastructure equipment 82, 83 may be non-terrestrial infrastructure equipment, and may comprise a plurality of transceivers 82.1, 83.1 these transceivers 82.1, 83.1 may have a one-to-one relationship with the transmitted spot beams.

In some arrangements of embodiments of the present technique, the physical cell identity (PCI) may be transferred or otherwise ensured between beams, and thus the UE may be able to continue the transmission after reselecting to a new cell/beam without re-establishment of any protocol entities and without the UE receiving a PDCP/RLC status report message. Here, the ACK status may be coordinated by the network (and shared between the source and target cells if necessary) and the UE is able to continue with the transmission from where it had left off in the previous cell.

In other words, in such arrangements of embodiments of the present disclosure, the second infrastructure equipment 83 may be configured to determine that the communications device has selected a cell of the wireless communications network formed by the infrastructure equipment 83 to continue the transmission of the uplink data, one or more of a plurality of portions of the uplink data having previously been transmitted by the communications device 81 to another cell of the wireless communications network formed by another infrastructure equipment 82, and to receive from the communications device 81, as the continued transmission of the uplink data, one or more portions of the uplink data which were not previously transmitted by the communications device 81 to the other cell, wherein an identifier of the second cell is the same as an identifier of the first cell.

In such arrangements of embodiments of the present disclosure, a PDCP (or RLC) status report in such cases may still be transmitted by the target cell to the UE, for example to provide the UE with information relating to the transmission status, but in such arrangements this is not necessary in the same manner as the arrangements described with reference to, for example, FIG. 8. In other words, the communications device may be configured to determine that the communications device has uplink data to transmit to the wireless communications network, to transmit to a first cell of the wireless communications network, while the communications device is located within a coverage region of the first cell, one or more of a plurality of portions of the uplink data, to determine, as a result of a change in a relative position of the communications device with respect to the coverage region of the first cell, that the communications device should select a different cell to continue the transmission of the uplink data, to select a second cell of the wireless communications network, and to receive, from the first cell, a status report message for use by the communications device in determining which of the plurality of portions of the uplink data have been successfully transmitted to the first cell. Here, an identifier of the second cell is the same as an identifier of the first cell.

While the present application refers in many examples to NTN, those skilled in the art would appreciate that embodiments of the present technique could equally apply to TN, UEs operating in accordance with a dual-connectivity mode between TN and NTN or handing over between TN and NTN, or indeed any other conceivable system or scenario in which the transmission of a PDCP status report (or other, e.g. RLC, status report) by the network to a UE would increase efficiency of operation of a UE where movement of the network infrastructure equipment (e.g. satellites) and/or movement of the UE causes interruptions in the transmission of uplink data by the UE. Specifically, embodiments of the present technique are most applicable to UEs such as, for example, NB-IoT UEs or SDT UEs for which the usage of PDCP status reports either are not applicable or is not defined in the relevant art. In NTN particularly, where satellites move with respect to the Earth's surface either during or between transmissions of uplink data and thus due to more frequent mobility the issues described above regarding interruption of uplink data transmissions are exacerbated, embodiments of the present disclosure provide solutions to handle those transmissions of uplink data by NB-IoT UEs or UEs performing SDT in a more efficient manner.

Essentially, embodiments of the present disclosure relate to the introduction of the reception of PDCP status reports by UEs (such as NB-IoT UEs or UE's in RRC_INACTIVE performing SDT) from the network, so that the UEs may send the remaining—or at least, only some of the total number of—PDUs of an uplink data transmission in the next cell after the UE has selected the next cell, having already transmitted some of the PDUs of the transmission in the previous cell.

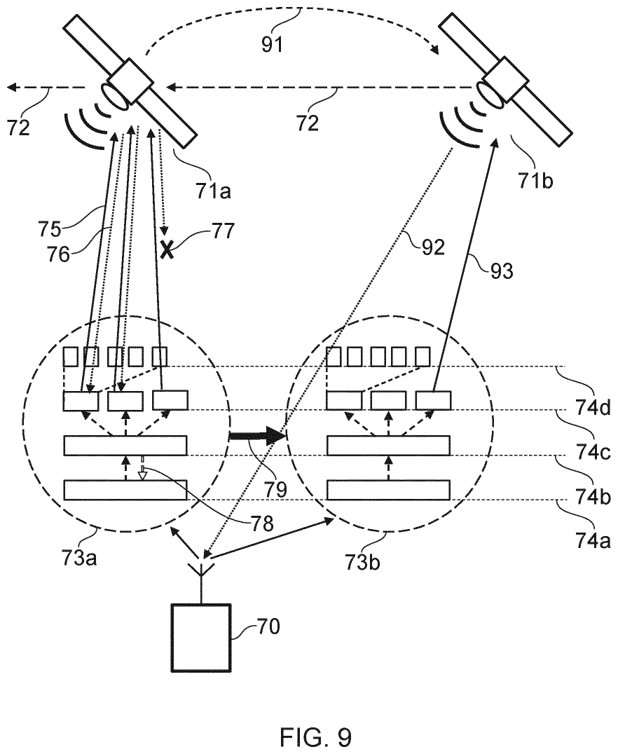

FIG. 9 shows an example, based on the example of FIG. 7, of how the UE 70 may more efficiently transmit uplink data to moving satellites 71a, 71b without having to retransmit the entire uplink data transmission 73a in accordance with embodiments of the present technique.

As can be seen in FIG. 9, as a part of the re-establishment procedure 79, the first satellite 71a (or first cell) may transmit an indication 91 to the second satellite 71b (or second cell) of whether/which PDCP/RLC/MAC PDUs were received successfully or unsuccessfully. This enables the second satellite 71b/second cell to transmit, to the UE 70 before it restarts/resumes the transmission 73b to the second satellite 71b/second cell, a PDCP status report message 92, providing the UE 70 with an indication of the third PDU segment having been successfully received by the first satellite 71a/first cell. Hence, the UE 70 knows not to flush its buffers of the already-transmitted PDU segments before reselecting to the new satellite/cell, and is able to restart the transmission 73b with the next PDU segment 93, or may start again by resending 93 the third PDU segment (but not the previous segments) in order to successfully receive the missed ACK 77 from the network. The UE 70 may be configured by the serving cell to not flush its buffers when e.g. cell selection/reselection occurs. The indication 91 of the PDUs (e.g. the one or more of the plurality of portions of uplink data received by the first infrastructure equipment/cell/satellite 71a from the UE 70 may comprise an indication of at least one sequence number of the PDUs successfully received by the first satellite 71a/first cell (e.g., the SNs of all received PDUs, the SN of the last received PDU, the first SN of a PDU that was not successfully received, where this indication is then used by the second satellite 71b (or second cell) to form the status report message sent 92 to the UE 70), or the indication 91 may comprise an indication of the (PDCP or RLC) status report message itself, which is then forwarded on 92 by the second satellite 71b (or second cell) to the UE 70.

With reference to FIG. 8, and as mentioned above, the step of determining 86 that the communications device should select a different cell to continue the transmission of the uplink data (and similar detection of this by the network) may be based on RLF or timer expiry (which can be used reliably due to the predictable ephemeris of a satellite). That is, such a step comprises detecting that RLF has occurred as a result of the change in the relative position of the communications device with respect to the coverage region of the first cell, and declaring the RLF. Furthermore, the steps of FIG. 8 of selecting 87 the second cell and receiving 88 the reconfiguration message may both form part of an RRC re-establishment procedure performed by the communications device with the wireless communications network. Alternatively, such a step of determining 86 that the communications device should select a different cell to continue the transmission of the uplink data may be based on detecting that a timer has expired, where this timer is based on the predictable orbit/movement of a satellite in NTN for example which means that it can be reliably known where the satellite/coverage provided by that satellite may be at any given time. Here, such a timer expiry being used for the performance of step 86 by the UE may applied to either an NB-IoT UE or a UE performing SDT in RRC_INACTIVE, for example. Alternatively, there could be a second timer configured specifically for SDT in order for the UE to declare an RLF-like mechanism (because SDT is performed in the INACTIVE state and Radio Link Monitoring (RLM)/RLF is a connected mode procedure). However, those skilled in the art would appreciate that the action (i.e. the RLF-like mechanism resulting in the determination that the UE should select a different cell, and subsequent reselection and re-establishment if needed) should be the same irrespective of whatever timer expires.

The implementation of transmitting PDCP status reports (or indeed RLC status reports) to NB-IoT UEs or inactive UEs performing SDT, as per embodiments of the present disclosure, may require changes to the UE context transferred between base stations; e.g. this may need to include the PDCP SN(s) (or the most recent SN), RLC SN or RLC ACK SN (for RLC-AM) which were confirmed to be received by the source or last serving eNB.

What the PDCP status report actually indicates to the UE may vary dependent on implementation. For example, the PDCP status report may indicate any one or more of the following:
Which PDU segments have been received;
Which PDU segments have not been received;
Which PDU segment the UE should start with when continuing the transmission in a new cell;
What was the last successfully transmitted PDU segment; and
What was the first unsuccessfully transmitted PDU.

Here, those skilled in the art would appreciate that the indication of the PDU segments may involve the indication of their sequence number(s) which define the order in which the PDU segments are transmitted, and that this may be a status from either of a PDCP entity or RLC entity.

In other words, the PDCP status report may indicate: which of the plurality of portions of the uplink data have been successfully received by the wireless communications network via the first cell, which of the plurality of portions of the uplink data have not been successfully received by the wireless communications network via the first cell, which of the plurality of portions of the uplink data should be the first portion of the uplink data to be transmitted to the second cell, which of the plurality of portions of the uplink data was most recently successfully received by the first cell, and/or which of the plurality of portions of the uplink data was the first of the plurality of portions of the uplink data to not be successfully received by the first cell.

It is likely that solutions defined by embodiments of the present disclosure will be introduced in a later release of the relevant specifications, and therefore there may be UEs (e.g. NB-IoT UEs or inactive UEs performing SDT) in the field which won't understand the new PDCP status report. Because of this, the network needs to be aware of a capability or receive some other form of signalling from the UE to understand if the UE will actually understand the new PDCP status report before it is sent. In other words, the wireless communications network (e.g. the infrastructure equipment which forms the second cell) may be configured to determine, before transmitting the reconfiguration message, that the communications device is capable of receiving and decoding the PDCP status report message. This may be based on the wireless communications network (e.g. the infrastructure equipment which forms the second cell) either receiving an indication from the communications device that the communications device is capable of receiving and decoding the PDCP status report message, or otherwise determining a capability of the communications device. Where such an indication is transmitted by the UE, this may be signalled at any appropriate time; for example, either before or after RLF or the like, when the UE is first deployed, on a periodic basis, or each time the UE connects to (a new cell of) the network. Furthermore, this indication may be signalled to any cell of the network, and may be relayed (if necessary) to the cell which actually sends the PDCP status report to the UE.

Alternatively, the UE capability may be determined based on the release of specification which provides such a definition for a particular type of UE. For example, the network may assume, based on 3GPP Release-17 or later, that an NB-IoT UE has the capability of being able to receive and understand PDCP status reports, and that UEs defined in earlier releases does not have such a capability.

For SDT UEs, there may be a requirement for such UEs to store the new information in the UE context and not perform presently defined actions (see [8]) such as setting the parameter TX NEXT to the initial value and discarding all stored PDCP PDUs from its buffer. Presently, as can be understood from [8], there appears to be no need in presently known systems for a PDCP status report to be transmitted when an SDT is triggered, as the UE's buffer would contain only new data. However, as is described herein, this may not be the case when mobility (due to movement of satellites for example) causes the UE to need to reselect a cell during transmission of small data—here a downlink PDCP status report is needed to be transmitted by the network upon the cell reselection procedure being performed by the UE with a new cell.

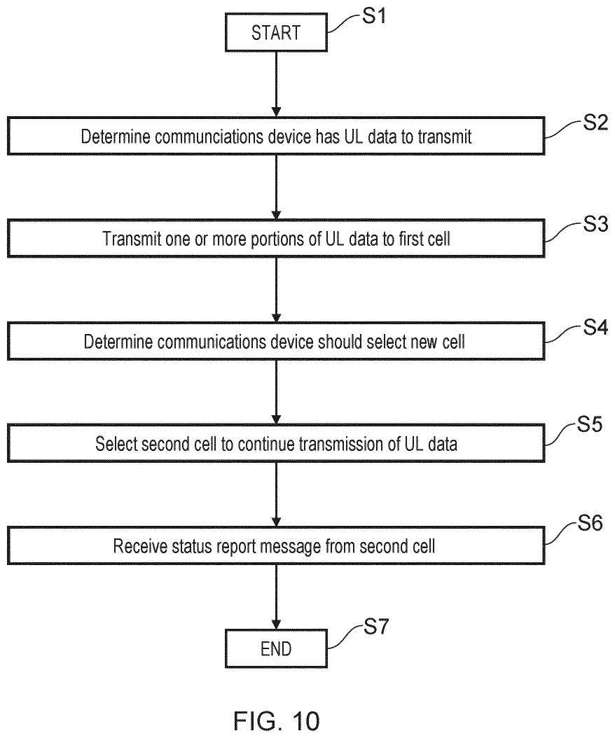

FIG. 10 shows a flow diagram illustrating a first example process of communications in a communications system in accordance with embodiments of the present technique. The process shown by FIG. 10 is a method of operating a communications device for transmitting signals to and/or receiving signals from a wireless communications network (e.g. to and/or from a plurality of infrastructure equipment of the wireless communications network).

The method begins in step S1. The method comprises, in step S2, determining that the communications device has uplink data to transmit to the wireless communications network. In step S3, the process comprises transmitting to a first cell of the wireless communications network, while the communications device is located within a coverage region of the first cell, one or more of a plurality of portions of the uplink data. The method then comprises, in step S4, determining, as a result of a change in a relative position of the communications device with respect to the coverage region of the first cell, that the communications device should select a different cell to continue the transmission of the uplink data. In step S5, the process comprises selecting a second cell of the wireless communications network before, in step S6, receiving, from the second cell, a reconfiguration message, wherein the reconfiguration message comprises a status report message for use by the communications device in determining which of the plurality of portions of the uplink data are to be transmitted to the second cell. The process ends in step S7.

Those skilled in the art would appreciate that the method shown by FIG. 10 may be adapted in accordance with embodiments of the present technique. For example, other intermediate steps may be included in the method, or the steps may be performed in any logical order. Furthermore, though embodiments of the present technique have been described largely by way of the example communications system shown in FIG. 8, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device for transmitting signals to and/or receiving signals from a wireless communications network, the method comprising
determining that the communications device has uplink data to transmit to the wireless communications network,
transmitting to a first cell of the wireless communications network, while the communications device is located within a coverage region of the first cell, one or more of a plurality of portions of the uplink data,
determining, as a result of a change in a relative position of the communications device with respect to the coverage region of the first cell, that the communications device should select a different cell to continue the transmission of the uplink data,
selecting a second cell of the wireless communications network, and
receiving, from the second cell, a reconfiguration message, wherein the reconfiguration message comprises a status report message for use by the communications device in determining which of the plurality of portions of the uplink data are to be transmitted to the second cell.

Paragraph 2. A method according to Paragraph 1, wherein the status report message is a packet data convergence protocol, PDCP, status report message.

Paragraph 3. A method according to Paragraph 1 or Paragraph 2, wherein the status report message is a radio link control, RLC, status report message.

Paragraph 4. A method according to any of Paragraphs 1 to 3, wherein the wireless communications network is a non-terrestrial network, NTN, and wherein the first cell and the second cell are each formed by non-terrestrial infrastructure equipment forming part of the NTN.

Paragraph 5. A method according to Paragraph 4, wherein the change in the relative position of the communications device with respect to the coverage region of the first cell is due to movement with respect to the ground of the non-terrestrial infrastructure equipment which forms the first cell.

Paragraph 6. A method according to any of Paragraphs 1 to 5, wherein the communications device operates in accordance with a Narrowband Internet of Things, NB-IoT, standard.

Paragraph 7. A method according to any of Paragraphs 1 to 6, wherein the step of determining that the communications device should select a different cell to continue the transmission of the uplink data comprises
detecting that a radio link failure, RLF, has occurred as a result of the change in the relative position of the communications device with respect to the coverage region of the first cell, and
declaring the RLF.

Paragraph 8. A method according to Paragraph 7, wherein the steps of selecting the second cell and receiving the reconfiguration message both form part of a Radio Resource Control, RRC, re-establishment procedure performed by the communications device with the wireless communications network.

Paragraph 9. A method according to any of Paragraphs 1 to 8, wherein the communications device is configured to transmit the uplink data to the wireless communications network while operating in an inactive state and without transitioning into a connected state with the wireless communications network.

Paragraph 10. A method according to any of Paragraphs 1 to 9, wherein the step of determining that the communications device should select a different cell to continue the transmission of the uplink data comprises detecting that a timer has expired.

Paragraph 11. A method according to any of Paragraphs 1 to 10, wherein the status report message indicates which of the plurality of portions of the uplink data have been successfully received by the wireless communications network via the first cell.

Paragraph 12. A method according to any of Paragraphs 1 to 11, wherein the status report message indicates which of the plurality of portions of the uplink data have not been successfully received by the wireless communications network via the first cell.

Paragraph 13. A method according to any of Paragraphs 1 to 12, wherein the status report message indicates which of the plurality of portions of the uplink data should be the first portion of the uplink data to be transmitted to the second cell.

Paragraph 14. A method according to any of Paragraphs 1 to 13, wherein the status report message indicates which of the plurality of portions of the uplink data was most recently successfully received by the first cell.

Paragraph 15. A method according to any of Paragraphs 1 to 14, wherein the status report message indicates which of the plurality of portions of the uplink data was the first of the plurality of portions of the uplink data to not be successfully received by the first cell.

Paragraph 16. A method according to any of Paragraphs 1 to 15, comprising
transmitting, before receiving the reconfiguration message, an indication to the wireless communications network that the communications device is capable of receiving and decoding the status report message.

Paragraph 17. A communications device comprising
transceiver circuitry configured to transmit signals to and/or to receive signals from a wireless communications network, and
controller circuitry configured in combination with the transceiver circuitry
to determine that the communications device has uplink data to transmit to the wireless communications network,
to transmit to a first cell of the wireless communications network, while the communications device is located within a coverage region of the first cell, one or more of a plurality of portions of the uplink data,
to determine, as a result of a change in a relative position of the communications device with respect to the coverage region of the first cell, that the communications device should select a different cell to continue the transmission of the uplink data,
to select a second cell of the wireless communications network, and
to receive, from the second cell, a reconfiguration message, wherein the reconfiguration message comprises a status report message for use by the communications device in determining which of the plurality of portions of the uplink data are to be transmitted to the second cell.

Paragraph 18. Circuitry for a communications device comprising
transceiver circuitry configured to transmit signals to and/or to receive signals from a wireless communications network, and
controller circuitry configured in combination with the transceiver circuitry
to determine that the communications device has uplink data to transmit to the wireless communications network,
to transmit to a first cell of the wireless communications network, while the communications device is located within a coverage region of the first cell, one or more of a plurality of portions of the uplink data,
to determine, as a result of a change in a relative position of the communications device with respect to the coverage region of the first cell, that the circuitry should select a different cell to continue the transmission of the uplink data,
to select a second cell of the wireless communications network, and
to receive, from the second cell, a reconfiguration message, wherein the reconfiguration messages comprise a status report message for use by the circuitry in determining which of the plurality of portions of the uplink data are to be transmitted to the second cell.

Paragraph 19. A method of operating a wireless communications network configured to transmit signals to and/or to receive signals from a communications device, the method comprising
receiving from the communications device by a first infrastructure equipment forming a first cell of the wireless communications network, while the communications device is located within a coverage region of the first cell, one or more of a plurality of portions of uplink data,
determining that the communications device has selected a second cell of the wireless communications network formed by a second infrastructure equipment to continue the transmission of the uplink data,
transmitting, by the first infrastructure equipment to the second infrastructure equipment, an indication of the one or more of the plurality of portions of uplink data received by the first infrastructure equipment from the communications device, and
transmitting, by the second infrastructure equipment to the communications device, a reconfiguration message, wherein the reconfiguration message comprises a status report message for use by the communications device in determining which of the plurality of portions of the uplink data are to be transmitted to the second infrastructure equipment.

Paragraph 20. A method according to Paragraph 19, wherein the status report message is a packet data convergence protocol, PDCP, status report message.

Paragraph 21. A method according to Paragraph 19 or Paragraph 20, wherein the status report message is a radio link control, RLC, status report message.

Paragraph 22. A method according to any of Paragraphs 19 to 21, wherein the wireless communications network is a non-terrestrial network, NTN, and wherein the first infrastructure equipment and the second infrastructure equipment are both non-terrestrial infrastructure equipment forming part of the NTN.

Paragraph 23. A method according to Paragraph 22, wherein selection by the communications device of the second cell to continue the transmission of the uplink data is based on a change in a relative position of the communications device with respect to the coverage region of the first cell due to movement with respect to the ground of the first infrastructure equipment Paragraph 24. A method according to any of Paragraphs 19 to 23, wherein the communications device operates in accordance with a Narrowband Internet of Things, NB-IoT, standard.

Paragraph 25. A method according to any of Paragraphs 19 to 24, wherein the step of determining that the communications device has selected the second cell to continue the transmission of the uplink data is based on determining that the communications device has declared radio link failure, RLF, a result of a change in a relative position of the communications device with respect to the coverage region of the first cell.

Paragraph 26. A method according to Paragraph 25, wherein the step transmitting the reconfiguration message forms part of a Radio Resource Control, RRC, re-establishment procedure performed by the wireless communications network with the communications device.

Paragraph 27. A method according to any of Paragraphs 19 to 26, wherein the step of determining that the communications device has selected the cell to continue the transmission of the uplink data comprises detecting that a timer has expired.

Paragraph 28. A method according to any of Paragraphs 19 to 27, wherein the wireless communications network is configured to receive the uplink data from the communications device while the communications device is operating in an inactive state and without transitioning into a connected state with the wireless communications network.

Paragraph 29. A method according to any of Paragraphs 19 to 28, wherein the status report message indicates which of the plurality of portions of the uplink data have been successfully received by the wireless communications network via the first infrastructure equipment.

Paragraph 30. A method according to any of Paragraphs 19 to 29, wherein the status report message indicates which of the plurality of portions of the uplink data have not been successfully received by the wireless communications network via the first infrastructure equipment.

Paragraph 31. A method according to any of Paragraphs 19 to 30, wherein the status report message indicates which of the plurality of portions of the uplink data should be the first portion of the uplink data to be transmitted to the second infrastructure equipment.

Paragraph 32. A method according to any of Paragraphs 19 to 31, wherein the status report message indicates which of the plurality of portions of the uplink data was most recently successfully received by the first infrastructure equipment.

Paragraph 33. A method according to any of Paragraphs 19 to 32, wherein the status report message indicates which of the plurality of portions of the uplink data was the first of the plurality of portions of the uplink data to not be successfully received by the first infrastructure equipment.

Paragraph 34. A method according to any of Paragraphs 19 to 33, comprising
determining, by the second infrastructure equipment before transmitting the reconfiguration message, that the communications device is capable of receiving and decoding the status report message.

Paragraph 35. A method according to Paragraph 34, wherein the determining that the communications device is capable of receiving and decoding the status report message is based on receiving, by the second infrastructure equipment, an indication from the communications device that the communications device is capable of receiving and decoding the status report message.

Paragraph 36. A method according to Paragraph 34 or Paragraph 35, wherein the determining that the communications device is capable of receiving and decoding the status report message is based on determining, by the second infrastructure equipment, a capability of the communications device.

Paragraph 37. A method according to any of Paragraph 19 to 36, wherein the indication of the one or more of the plurality of portions of uplink data received by the first infrastructure equipment from the communications device comprises an indication of at least one sequence number of the one or more of the plurality of portions of uplink data received by the first infrastructure equipment from the communications device.

Paragraph 38. A method according to any of Paragraph 19 to 37, wherein the indication of the one or more of the plurality of portions of uplink data received by the first infrastructure equipment from the communications device comprises an indication of the status report message.

Paragraph 39. A wireless communications network comprising a plurality of infrastructure equipment each forming a cell of the wireless communications network, wherein a first of the infrastructure equipment comprises
transceiver circuitry configured to transmit signals to and/or to receive signals from a communications device, and
controller circuitry configured in combination with the transceiver circuitry
to receive from the communications device, while the communications device is located within a coverage region of a first cell formed by the first infrastructure equipment, one or more of a plurality of portions of uplink data,
to determine that the communications device has selected a second cell of the wireless communications network formed by a second of the infrastructure equipment to continue the transmission of the uplink data,
to transmit, to the second infrastructure equipment, an indication of the one or more of the plurality of portions of uplink data received by the first infrastructure equipment from the communications device, and wherein the second infrastructure equipment comprises
transceiver circuitry configured to transmit signals to and/or to receive signals from the communications device, and
controller circuitry configured in combination with the transceiver circuitry
to transmit, to the communications device, a reconfiguration message, wherein the reconfiguration message comprises a status report message for use by the communications device in determining which of the plurality of portions of the uplink data are to be transmitted to the second infrastructure equipment.

Paragraph 40. Circuitry for a wireless communications network comprising a plurality of infrastructure equipment each forming a cell of the wireless communications network, wherein a first of the infrastructure equipment comprises
transceiver circuitry configured to transmit signals to and/or to receive signals from a communications device, and
controller circuitry configured in combination with the transceiver circuitry
to receive from the communications device, while the communications device is located within a coverage region of a first cell formed by the first infrastructure equipment, one or more of a plurality of portions of uplink data, and
to determine that the communications device has selected a second cell of the wireless communications network formed by a second of the infrastructure equipment to continue the transmission of the uplink data,
to transmit, to the second infrastructure equipment, an indication of the one or more of the plurality of portions of uplink data received by the first infrastructure equipment from the communications device, and wherein the second infrastructure equipment comprises
transceiver circuitry configured to transmit signals to and/or to receive signals from the communications device, and
controller circuitry configured in combination with the transceiver circuitry
to transmit, to the communications device, a reconfiguration message, wherein the reconfiguration message comprises a status report message for use by the communications device in determining which of the plurality of portions of the uplink data are to be transmitted to the second infrastructure equipment.

Paragraph 41. A method of operating an infrastructure equipment forming part of a wireless communications network, the infrastructure equipment being configured to transmit signals to and/or to receive signals from a communications device, the method comprising
determining that the communications device has selected a cell of the wireless communications network formed by the infrastructure equipment to continue the transmission of the uplink data, one or more of a plurality of portions of the uplink data having previously been transmitted by the communications device to another cell of the wireless communications network formed by another infrastructure equipment,
receiving, from the other cell, an indication of the one or more of the plurality of portions of uplink data received by the other cell from the communications device, and
transmitting, to the communications device, a reconfiguration message, wherein the reconfiguration message comprises a status report message for use by the communications device in determining which of the plurality of portions of the uplink data are to be transmitted to the infrastructure equipment.

Paragraph 42. An infrastructure equipment forming part of a wireless communications network, comprising
transceiver circuitry configured to transmit signals to and/or to receive signals from a communications device, and
controller circuitry configured in combination with the transceiver circuitry
to determine that the communications device has selected a cell of the wireless communications network formed by the infrastructure equipment to continue the transmission of the uplink data, one or more of a plurality of portions of the uplink data having previously been transmitted by the communications device to another cell of the wireless communications network formed by another infrastructure equipment,
to receive, from the other cell, an indication of the one or more of the plurality of portions of uplink data received by the other cell from the communications device, and
to transmit, to the communications device, a reconfiguration message, wherein the reconfiguration message comprises a status report message for use by the communications device in determining which of the plurality of portions of the uplink data are to be transmitted to the infrastructure equipment.

Paragraph 43. Circuitry for an infrastructure equipment forming part of a wireless communications network, comprising
transceiver circuitry configured to transmit signals to and/or to receive signals from a communications device, and
controller circuitry configured in combination with the transceiver circuitry
to determine that the communications device has selected a cell of the wireless communications network formed by the circuitry to continue the transmission of the uplink data, one or more of a plurality of portions of the uplink data having previously been transmitted by the communications device to another cell of the wireless communications network formed by another infrastructure equipment,
to receive, from the other cell, an indication of the one or more of the plurality of portions of uplink data received by the other cell from the communications device, and
to transmit, to the communications device, a reconfiguration message, wherein the reconfiguration message comprises a status report message for use by the communications device in determining which of the plurality of portions of the uplink data are to be transmitted to the circuitry.

Paragraph 44. A method of operating an infrastructure equipment forming part of a wireless communications network, the infrastructure equipment being configured to transmit signals to and/or to receive signals from a communications device, the method comprising
determining that the communications device has selected a cell of the wireless communications network formed by the infrastructure equipment to continue the transmission of the uplink data, one or more of a plurality of portions of the uplink data having previously been transmitted by the communications device to another cell of the wireless communications network formed by another infrastructure equipment, and
receiving from the communications device, as the continued transmission of the uplink data, one or more portions of the uplink data which were not previously transmitted by the communications device to the other cell, wherein an identifier of the second cell is the same as an identifier of the first cell.

Paragraph 45. An infrastructure equipment forming part of a wireless communications network, comprising
transceiver circuitry configured to transmit signals to and/or to receive signals from a communications device, and
controller circuitry configured in combination with the transceiver circuitry
to determine that the communications device has selected a cell of the wireless communications network formed by the infrastructure equipment to continue the transmission of the uplink data, one or more of a plurality of portions of the uplink data having previously been transmitted by the communications device to another cell of the wireless communications network formed by another infrastructure equipment, and
to receive from the communications device, as the continued transmission of the uplink data, one or more portions of the uplink data which were not previously transmitted by the communications device to the other cell, wherein an identifier of the second cell is the same as an identifier of the first cell.

Paragraph 46. Circuitry for an infrastructure equipment forming part of a wireless communications network, comprising
transceiver circuitry configured to transmit signals to and/or to receive signals from a communications device, and
controller circuitry configured in combination with the transceiver circuitry
to determine that the communications device has selected a cell of the wireless communications network formed by the circuitry to continue the transmission of the uplink data, one or more of a plurality of portions of the uplink data having previously been transmitted by the communications device to another cell of the wireless communications network formed by another infrastructure equipment, and
to receive from the communications device, as the continued transmission of the uplink data, one or more portions of the uplink data which were not previously transmitted by the communications device to the other cell, wherein an identifier of the second cell is the same as an identifier of the first cell.

Paragraph 47. A method of operating a communications device for transmitting signals to and/or receiving signals from a wireless communications network, the method comprising
determining that the communications device has uplink data to transmit to the wireless communications network,
transmitting to a first cell of the wireless communications network, while the communications device is located within a coverage region of the first cell, one or more of a plurality of portions of the uplink data,
determining, as a result of a change in a relative position of the communications device with respect to the coverage region of the first cell, that the communications device should select a different cell to continue the transmission of the uplink data,
selecting a second cell of the wireless communications network, and
receiving, from the first cell, a status report message for use by the communications device in determining which of the plurality of portions of the uplink data have been successfully transmitted to the first cell,
wherein an identifier of the second cell is the same as an identifier of the first cell.

Paragraph 48. A communications device comprising
transceiver circuitry configured to transmit signals to and/or to receive signals from a wireless communications network, and
controller circuitry configured in combination with the transceiver circuitry
to determine that the communications device has uplink data to transmit to the wireless communications network,
to transmit to a first cell of the wireless communications network, while the communications device is located within a coverage region of the first cell, one or more of a plurality of portions of the uplink data,
to determine, as a result of a change in a relative position of the communications device with respect to the coverage region of the first cell, that the communications device should select a different cell to continue the transmission of the uplink data,
to select a second cell of the wireless communications network, and
to receive, from the first cell, a status report message for use by the communications device in determining which of the plurality of portions of the uplink data have been successfully transmitted to the first cell,
wherein an identifier of the second cell is the same as an identifier of the first cell.

Paragraph 49. Circuitry for a communications device comprising
transceiver circuitry configured to transmit signals to and/or to receive signals from a wireless communications network, and
controller circuitry configured in combination with the transceiver circuitry to determine that the communications device has uplink data to transmit to the wireless communications network,
to transmit to a first cell of the wireless communications network, while the communications device is located within a coverage region of the first cell, one or more of a plurality of portions of the uplink data,
to determine, as a result of a change in a relative position of the communications device with respect to the coverage region of the first cell, that the circuitry should select a different cell to continue the transmission of the uplink data,
to select a second cell of the wireless communications network, and
to receive, from the first cell, a status report message for use by the communications device in determining which of the plurality of portions of the uplink data have been successfully transmitted to the first cell,
wherein an identifier of the second cell is the same as an identifier of the first cell.

Paragraph 50. A computer program comprising instructions which, when loaded onto a computer, cause the computer to perform a method according to any of Paragraphs 1 to 16, Paragraphs 19 to 38, Paragraph 41, Paragraph 44 or Paragraph 47.

Paragraph 51. A non-transitory computer-readable storage medium storing a computer program according to Paragraph 50.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR 38.811 V15.4.0, “Study on New Radio (NR) to support non terrestrial networks (Release 15)”, 3rd Generation Partnership Project, October 2020.
[2] Holma H. and Toskala A, “LTE for UMTS OFDMA and SC-FDMA based radio access”, John Wiley and Sons, 2009.
[3] RP-193252, “New Work Item on NR small data transmission in INACTIVE state,” ZTE Corporation, 3GPP TSG RAN Meeting #86.
[4] TR 38.821 V16.0.0, “Solutions for NR to support Non-Terrestrial Networks (NTN)” 3rd Generation Partnership Project, January 2020.
[5] RP-202908, “Solutions for NR to support non-terrestrial networks (NTN)”, Thales, RANP #90e, December 2020.
[6] RP-193235, “New Study WID on NB-IoT/eMTC support for NTN”, MediaTek Inc. RANP #86, December 2019.
[7] TS 36.323 V16.3.0, “Evolved Universal Terrestrial Radio Access (E-UTRA); Packet Data Convergence Protocol (PDCP) specification”, 3rd Generation Partnership Project, January 2021.
[8] R2-2101183, “User plane common aspects for SDT”, Huawei, HiSilicon, 3GPP TSG RAN WG2 #113-e, January-February 2021.

1. A method of operating a communications device for transmitting signals to and/or receiving signals from a wireless communications network, the method comprising
determining that the communications device has uplink data to transmit to the wireless communications network,
transmitting to a first cell of the wireless communications network, while the communications device is located within a coverage region of the first cell, one or more of a plurality of portions of the uplink data,
determining, as a result of a change in a relative position of the communications device with respect to the coverage region of the first cell, that the communications device should select a different cell to continue the transmission of the uplink data,
selecting a second cell of the wireless communications network, and
receiving, from the second cell, a reconfiguration message, wherein the reconfiguration message comprises a status report message for use by the communications device in determining which of the plurality of portions of the uplink data are to be transmitted to the second cell.

2. A method according to claim 1, wherein the status report message is a packet data convergence protocol, PDCP, status report message.

3. A method according to claim 1, wherein the status report message is a radio link control, RLC, status report message.

4. A method according to claim 1, wherein the wireless communications network is a non-terrestrial network, NTN, and wherein the first cell and the second cell are each formed by non-terrestrial infrastructure equipment forming part of the NTN.

5. A method according to claim 4, wherein the change in the relative position of the communications device with respect to the coverage region of the first cell is due to movement with respect to the ground of the non-terrestrial infrastructure equipment which forms the first cell.

6. A method according to claim 1, wherein the communications device operates in accordance with a Narrowband Internet of Things, NB-IoT, standard.

7. A method according to claim 1, wherein the step of determining that the communications device should select a different cell to continue the transmission of the uplink data comprises
detecting that a radio link failure, RLF, has occurred as a result of the change in the relative position of the communications device with respect to the coverage region of the first cell, and
declaring the RLF.

8. A method according to claim 7, wherein the steps of selecting the second cell and receiving the reconfiguration message both form part of a Radio Resource Control, RRC, re-establishment procedure performed by the communications device with the wireless communications network.

9. A method according to claim 1, wherein the communications device is configured to transmit the uplink data to the wireless communications network while operating in an inactive state and without transitioning into a connected state with the wireless communications network.

10. A method according to claim 1, wherein the step of determining that the communications device should select a different cell to continue the transmission of the uplink data comprises detecting that a timer has expired.

11. A method according to claim 1, wherein the status report message indicates which of the plurality of portions of the uplink data have been successfully received by the wireless communications network via the first cell.

12. A method according to claim 1, wherein the status report message indicates which of the plurality of portions of the uplink data have not been successfully received by the wireless communications network via the first cell.

13. A method according to claim 1, wherein the status report message indicates which of the plurality of portions of the uplink data should be the first portion of the uplink data to be transmitted to the second cell.

14. A method according to claim 1, wherein the status report message indicates which of the plurality of portions of the uplink data was most recently successfully received by the first cell.

15. A method according to claim 1, wherein the status report message indicates which of the plurality of portions of the uplink data was the first of the plurality of portions of the uplink data to not be successfully received by the first cell.

16. A method according to claim 1, comprising
transmitting, before receiving the reconfiguration message, an indication to the wireless communications network that the communications device is capable of receiving and decoding the status report message.

17. A communications device comprising
transceiver circuitry configured to transmit signals to and/or to receive signals from a wireless communications network, and
controller circuitry configured in combination with the transceiver circuitry
to determine that the communications device has uplink data to transmit to the wireless communications network,
to transmit to a first cell of the wireless communications network, while the communications device is located within a coverage region of the first cell, one or more of a plurality of portions of the uplink data,
to determine, as a result of a change in a relative position of the communications device with respect to the coverage region of the first cell, that the communications device should select a different cell to continue the transmission of the uplink data,
to select a second cell of the wireless communications network, and
to receive, from the second cell, a reconfiguration message, wherein the reconfiguration message comprises a status report message for use by the communications device in determining which of the plurality of portions of the uplink data are to be transmitted to the second cell.

18.-41. (canceled)

42. An infrastructure equipment forming part of a wireless communications network, comprising
transceiver circuitry configured to transmit signals to and/or to receive signals from a communications device, and
controller circuitry configured in combination with the transceiver circuitry
to determine that the communications device has selected a cell of the wireless communications network formed by the infrastructure equipment to continue the transmission of the uplink data, one or more of a plurality of portions of the uplink data having previously been transmitted by the communications device to another cell of the wireless communications network formed by another infrastructure equipment,
to receive, from the other cell, an indication of the one or more of the plurality of portions of uplink data received by the other cell from the communications device, and
to transmit, to the communications device, a reconfiguration message, wherein the reconfiguration message comprises a status report message for use by the communications device in determining which of the plurality of portions of the uplink data are to be transmitted to the infrastructure equipment.

43.-51. (canceled)
